(19) United States
(12) Patent Application Publication
(10) Pub. No.: US 2023/0394880 A1
(43) Pub. Date: Dec. 7, 2023

(54) SYSTEMS AND METHODS FOR MONITORING SOCIAL DISTANCING USING MOTION SENSORS

(71) Applicant: SIGNIFY HOLDING B.V., EINDHOVEN (NL)

(72) Inventors: ABHISHEK MURTHY, ARLINGTON, MA (US); DAKSHA YADAV, BOSTON, MA (US); JIN YU, LEXINGTON, MA (US); PETER DEIXLER, ARLINGTON, MA (US)

(21) Appl. No.: 18/031,634

(22) PCT Filed: Oct. 8, 2021
(86) PCT No.: PCT/EP2021/077916

§ 371 Date: Apr. 13, 2023

Related U.S. Application Data
(60) Provisional application No. 63/093,538, filed on Oct. 19, 2020.

(30) Foreign Application Priority Data
Nov. 12, 2020 (EP) 20207289.8

(51) Int. Cl. G06V 40/20; G06V 10/72; G06V 10/12

(52) U.S. Cl. CPC G06V 40/20; G06V 10/72; G06V 10/12

(57) ABSTRACT

A system for monitoring social distancing is provided. The system includes a controller communicatively coupled to sensors within an environment. The controller may be configured to (1) receive an expected sensor behavior model for each of the sensors; (2) generate an adjusted sensor behavior model for each of the sensors based on the expected sensor behavior model for each of the sensors and an environment adjustment model for each of the sensors; (3) receive a layout of the environment; (4) generate an expected layout behavior model based on the layout and the adjusted sensor behavior model; (5) capture, via the sensors, an observed behavior data set during a measurement period; and (6) determine a social distancing state of individuals in the environment as distanced or not-distanced based on the observed behavior data set and the expected layout behavior model.

### FIELD OF THE DISCLOSURE

The present disclosure is directed generally to monitoring social distancing using motion sensors.

### BACKGROUND

The COVID-19 pandemic has changed open office environments in many ways. One of the main changes has been the enforcement of social distancing policies, which requires occupants of the office environment to sit far away from each other. This may result in only a subset of desks being available to use at any given time.

Further, in addition to social distancing policies, physical barriers may need to be installed in office environments, often in the form of acrylic glass shields and dividers, to protect the workers from sneezes and other sources of the virus. Implementing these glass shields will impact the information collected by available monitoring systems. Accordingly, there is a need to automatically monitor the enforcement of such policies despite the installation of acrylic glass shields and dividers in office environments.

### SUMMARY OF THE DISCLOSURE

The present disclosure is generally directed to systems and methods for monitoring social distancing in an environment with workstations separated by barriers, such as acrylic glass or the like, using motion sensors, such as passive infrared (“PIR”) sensors. The PIR sensors are configured to count the number of minor motions, medium motions, and major motions in their field of view. The system receives an expected sensor behavior model for each sensor, which includes probability distributions for each of the motion counts depending on the number of occupied workstations in their field of view. The system then adjusts the expected behavior model for losses due to the glass barriers. The system then receives a layout of the environment which shows placement of workstations, occupancy status of the workstations, and placement of the sensors. Based on the layout and the adjusted sensor behavior model, the system generates an expected layout behavior model, which includes probability distribution totals of each of the motion counts throughout the entire layout when social distancing is practiced. The system then uses the sensors to capture data of the environment during normal operation, and compares that data to the expected layout behavior model to classify the environment as “distanced” or “not-distanced”.

Generally, in one aspect, a system for monitoring social distancing of individuals in an environment with a plurality of workstations separated by one or more barriers is provided. The barriers may be acrylic glass.

The system includes a controller communicatively coupled to one or more sensors within the environment. The one or more sensors may include one or more PIR sensors, one or more single pixel thermopile sensors (“SPT”), one or more multipixel thermopile (“MPT”) sensors, and/or one or more microwave radar sensors. The one or more sensors may be arranged in one or more luminaires. The one or more luminaires may be positioned above the plurality of workstations.

The controller may be configured to receive an expected sensor behavior model for each of the one or more sensors. The expected sensor behavior model for each of the one or more sensors may include a sensor minor motion probability distribution, a sensor medium motion probability distribution, and a sensor major motion probability distribution.

The controller may be further configured to generate an adjusted sensor behavior model for each of the one or more sensors. The adjusted behavior sensor model may be generated based on the expected sensor behavior model for each of the one or more sensors and an environment adjustment model for each of the one or more sensors.

The controller may be further configured to receive a layout of the environment. The layout may include a plurality of workstation locations. The layout may also include one or more sensor locations. Each workstation location may have an occupancy state of occupied or unoccupied.

The controller may be further configured to generate an expected layout behavior model. The expected layout behavior model may be generated based on the layout and the adjusted sensor behavior model. The expected layout behavior model may include a layout minor motion probability distribution, a layout medium motion probability distribution, and a layout major motion probability distribution.

The controller may be further configured to capture, via the one or more sensors, an observed behavior data set during a measurement period. The observed behavior data set may include an observed minor motion count, an observed medium motion count, and an observed major motion count. The measurement period may be five minutes.

The controller may be further configured to determine a social distancing state of individuals in the environment as distanced or not-distanced based on the observed behavior data set and the expected layout behavior model.

According to an example, the controller may be further configured to capture, via the one or more sensors, an environmental behavior data set when the environment is unoccupied.

The controller may be further configured to calculate the environment adjustment model for each of the one or more sensors. The environmental adjustment model may be calculated based on the environmental behavior data set and the expected behavior model for each of the one or more sensors.

According to an example, the social distancing state may be determined by (1) calculating, via a hypothesis test, a social distancing p-value based on the observed behavior data set and the expected layout behavior model; (2) assigning, if the social distancing p-value is less than or equal to a social distancing threshold, the social distancing state to distanced; and (3) assigning, if the social distancing p-value is greater than the social distancing threshold, the social distancing state to not-distanced.

According to an example, the controller may be further configured to transmit a warning signal if the social distancing state of the environment is not-distanced.

In another aspect, a method for monitoring social distancing of individuals an environment with a plurality of workstations separated by one or more barriers is provided. The method may include receiving, via a controller communicatively coupled to one or more sensors within the environment, an expected behavior model for each of the one or more sensors.

The method may further include generating an adjusted behavior model for each of the one or more sensors based on the expected behavior model for each of the one or more sensors and an environment adjustment model for each of the one or more sensors. The method may further include receiving a layout of the environment, the layout comprising the plurality of workstations and the one or more sensors, wherein each workstation has an occupancy state of occupied or unoccupied. The method may further include generating an expected layout behavior model based on the layout and the adjusted behavior model. The method may further include capturing, via the one or more sensors, an observed behavior data set during a measurement period. The method may further include determining a social distancing state of the individuals in the environment as distanced or not-distanced based on the observed behavior data set and the expected layout behavior model.

According to an example, the method may further include capturing, via the one or more sensors, an environmental behavior data set when the environment is unoccupied. The method may further include calculating the environment adjustment model for each of the one or more sensors based on the environmental behavior data set and the expected behavior model for each of the one or more sensors.

According to an example, determining the social distancing state may include calculating, via a hypothesis test, a social distancing p-value based on the observed behavior data set and the expected layout behavior model. Determining the social distancing state may further include assigning, if the social distancing p-value is less than or equal to a social distancing threshold, the social distancing state to distanced. Determining the social distancing state may include assigning, if the social distancing p-value is greater than the social distancing threshold, the social distancing state to not-distanced.

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a top-level schematic of a system for monitoring social distancing, in accordance with an example.

FIG. 2 is a schematic of a luminaire in a system for monitoring social distancing, in accordance with an example.

FIG. 3 is a schematic of a controller in a system for monitoring social distancing, in accordance with an example.

FIG. 4 is a layout of an environment monitored for social distancing, in accordance with an example.

FIG. 5 is a plot showing two example analog signals generated by a passive infrared (PIR) sensor, in accordance with an example.

FIG. 6 shows an expected sensor behavior model, which includes expected probability distributions of minor, medium, and major motions detected when k=1, 2, and 3 occupied workstations are in the field of view of a PIR sensor, in accordance with an example.

FIG. 7 shows an expected layout behavior model, which includes expected probability distributions of minor, medium, and major motions detected by the PIR sensors in an observed environment for an example layout of desks and social distancing policy, in accordance with an example.

FIG. 8 is a flowchart of a method for monitoring social distancing, in accordance with an example.

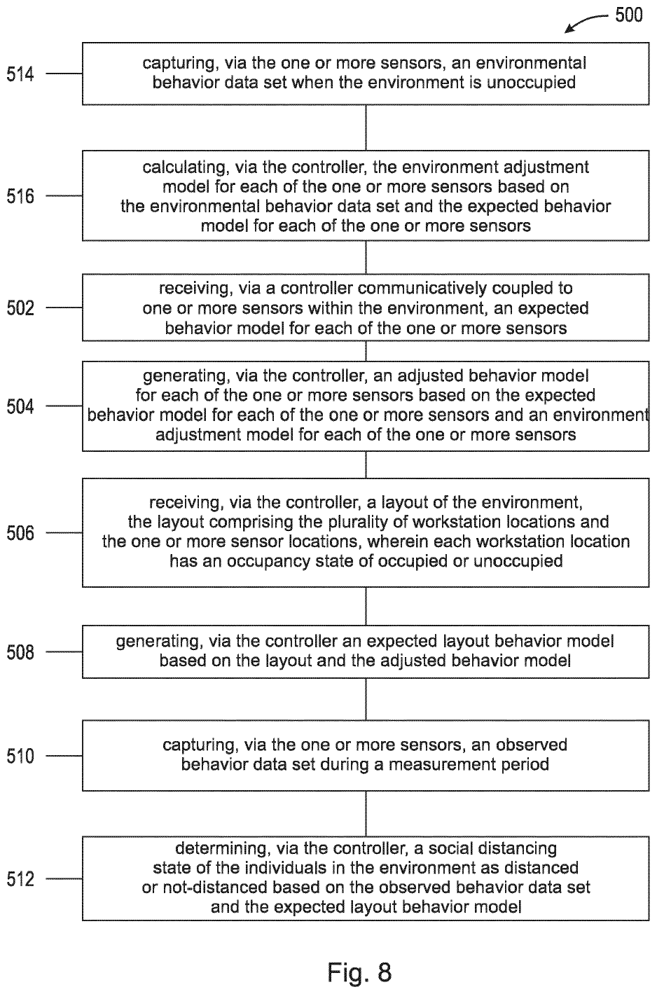

FIG. 9 is a flowchart for the determining a social distancing state aspect of the method for monitoring social distancing, in accordance with an example.

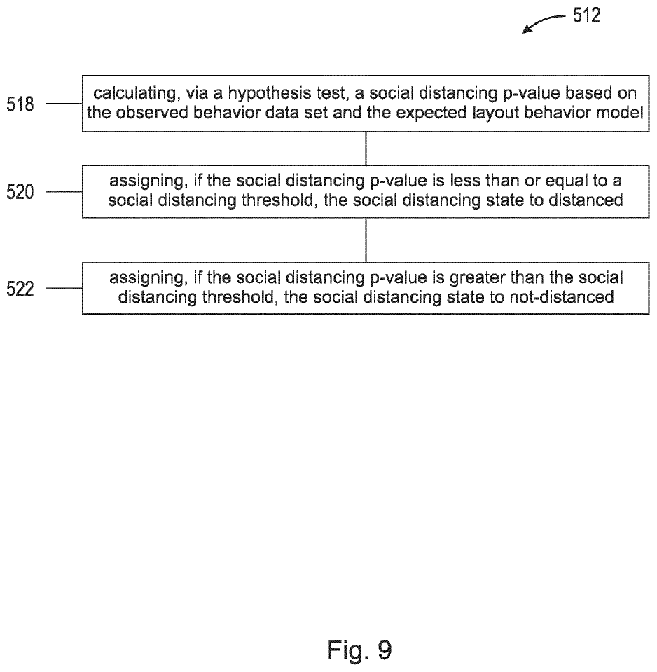

### DETAILED DESCRIPTION OF EMBODIMENTS

The present disclosure is generally directed to systems and methods for monitoring social distancing in an environment with workstations separated by barriers, such as acrylic glass or the like, using motion sensors, such as passive infrared (“PIR”) sensors. The PIR sensors are configured to count the number of minor motions, medium motions, and major motions in their field of view. The sensors may be arranged in luminaires positioned around the environment. The system receives an expected sensor behavior model for each sensor, which includes probability distributions for each of the motion counts depending on the number of occupied workstations in their field of view. The system then adjusts the expected behavior model for losses due to the glass barriers. This adjustment may be based on an environment adjustment model, which is based on sensor data captured when the environment is occupied. The system then receives a layout of the environment which shows placement of workstations, occupancy status of the workstations, and placement of the sensors. Based on the layout and the adjusted sensor behavior model, the system generates an expected layout behavior model, which includes probability distribution totals of each of the motion counts throughout the entire layout when social distancing is practiced. The system then uses the sensors to capture data of the environment during normal operation, and compares that data to the expected layout behavior model to classify the environment as “distanced” or “not-distanced”. This comparison may be performed by calculating a social-distancing p-value via a hypothesis test.

Generally, in one aspect, a system 100 for monitoring social distancing of individuals in an environment 104 with a plurality of workstations 106 separated by one or more barriers 108 is provided. Social distancing may be monitored to slow the spread of infectious disease. In other examples, the system 100 may also be used to monitor social distancing for other purposes, such as prevention of inmate comingling in a prison environment.

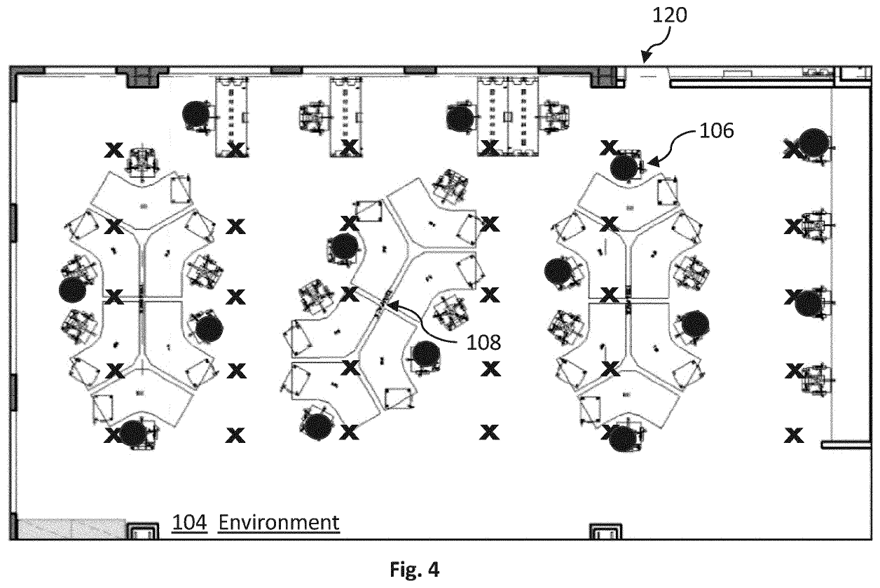

The barriers 108 may be acrylic glass or the like (e.g., Plexiglas® acrylic). The barriers 108 may be transparent or translucent. An example layout 120 of an environment 104 is shown in FIG. 4. This environment 104 includes three clusters of six boomerang-shaped desks, two single rectangular desks adjacent to the north wall, a double rectangular desk adjacent to the north wall, and one long table with four workstations 106 adjacent to the east wall. The layout 120 may include barriers 108 placed between the workstations 106, as shown in FIG. 4.

While a workstation 106 may typically be a desk or table in an office, the system 100 may be configured to monitor other types of environments as well. For example, the environment 104 may be a manufacturing plant, and the workstations 106 may be areas on an assembly line. In another example, the environment 104 may be a commercial kitchen, and the workstations 106 may be prep stations or areas proximate to kitchen appliances (such as ovens, fryers, grills, etc.).

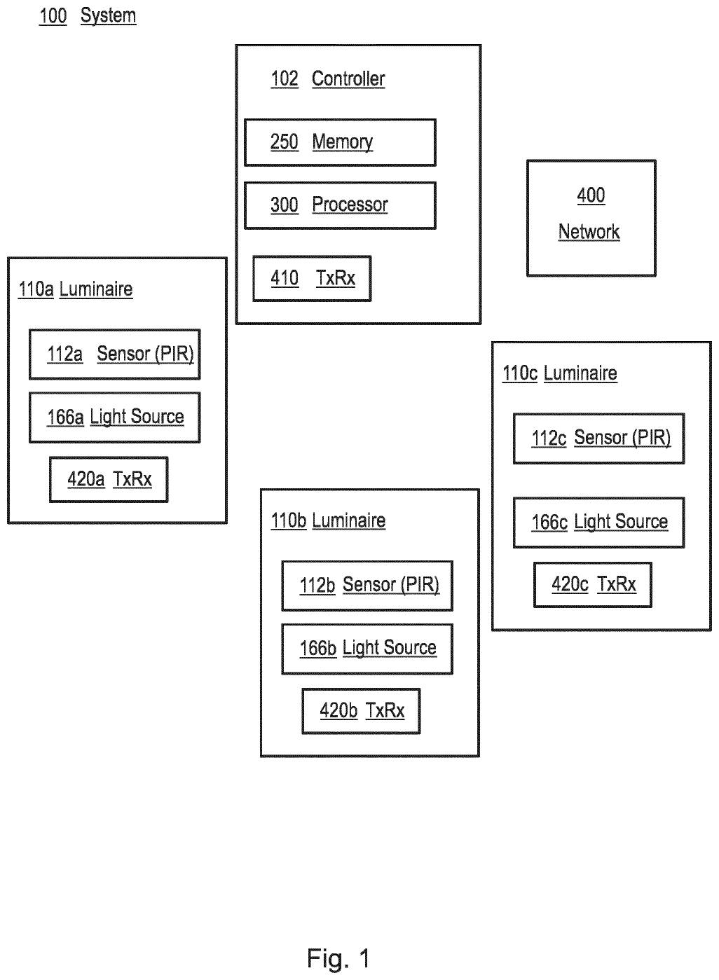

Broadly, and with reference to FIG. 1, the system 100 may include a controller 102 and one or more luminaires 110. Each of the luminaires 110 may include components such as sensors 112, light sources 166, and/or transceivers 420. The controller 102 may be capable of communication with the components of the luminaires 110 via wired or wireless network 400. FIG. 1 depicts an example system 100 which includes three luminaires 110a-c, each luminaire 110a-c having a PIR sensor 112a-c, light source 166a-c, and transceiver 420a-c.

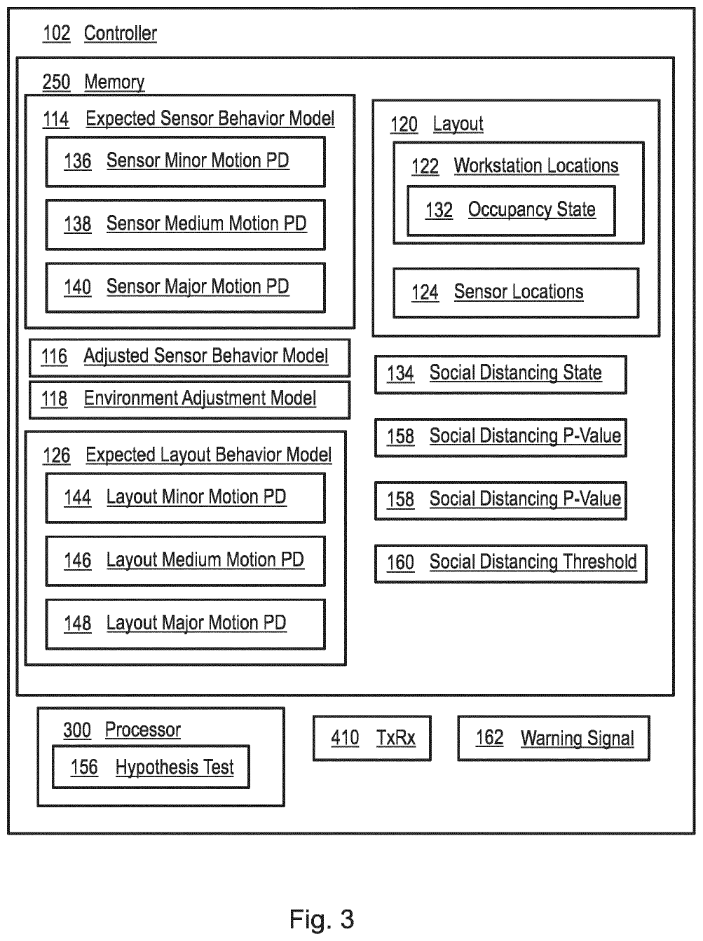

With reference to FIGS. 1 and 3, the controller 102 may include a memory 250, a processor 300, and a transceiver 410. The memory 250 and processor 300 may be communicatively coupled via a bus to facilitate processing of data stored in memory 300. Transceiver 410 may be used to receive data from the one or more sensors 106 via the network 400. The data received by the transceiver 410 may be stored in memory 250 and/or processed by processor 300. In an example, the transceiver 410 may facilitate a wireless connection between the controller 106 and the network 400. The transceiver 410 may also be used to operate the light sources 166 of the luminaires 110.

The network 400 may be configured to facilitate communication between the controller 102, the one or more sensors 112, the one or more light sources 166, and/or any combination thereof. The network 400 may be a wired and/or wireless network following communication protocols such as cellular network (5G, LTE, etc.), Bluetooth, Wi-Fi, Zigbee, and/or other appropriate communication protocols. In an example, the PIR sensors 112 may wirelessly transmit, via the network 400, an observed behavior data set 128 or environmental behavior data set 142 to the controller 102 for storage in memory 250 and/or processing by the processor 300.

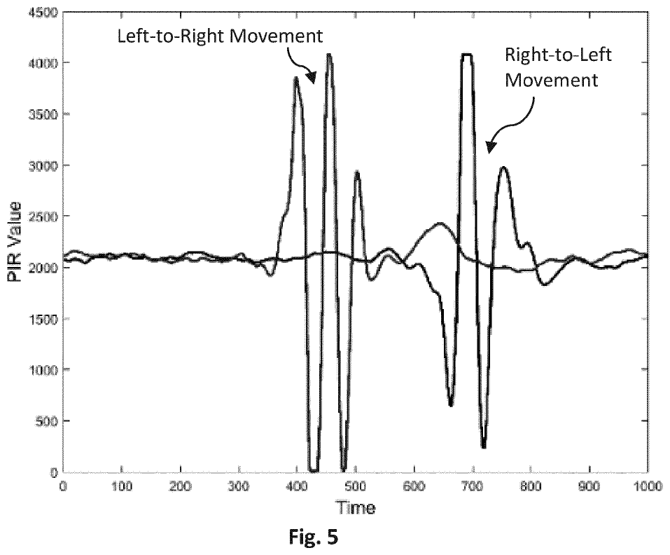

The system 100 includes a controller 102 communicatively coupled to one or more sensors 112 within the environment 104. The one or more sensors 112 may include one or more PIR sensors, one or more single pixel thermopile sensors (“SPT”), one or more multipixel thermopile (“MPT”) sensors, and/or one or more microwave radar sensors. PIR sensors are configured to detect infrared energy, and can therefore be used to detect warmth radiated by a human body. Each sensor 112 has a field of view covering a portion of the environment 104. A pair of example waveforms generated by PIR sensors are shown in FIG. 5. In FIG. 5, the excitation shown in time interval 400-500 is indicative of a left-to-right movement, while the excitation in time interval 650-800 is indicative of a right-to-left movement. These waveforms are translated into three types of motion counts: minor, medium, and major. A minor motion may correspond to the normal motions of a worker sitting at their desk, such as typing on a keyboard, moving a mouse, or talking into a telephone. A medium motion may correspond to a worker standing up or sitting down. A major motion may correspond to a worker entering or exiting their workstation area. As will be described below, these motion counts may be analyzed to determine if the individuals in the environment 104 are social-distanced. In further examples, information collected by SPT sensors, MPT sensors, or microwave radar sensors may be similarly used to track movement within the environment, either separately or in combination with the PIR sensors.

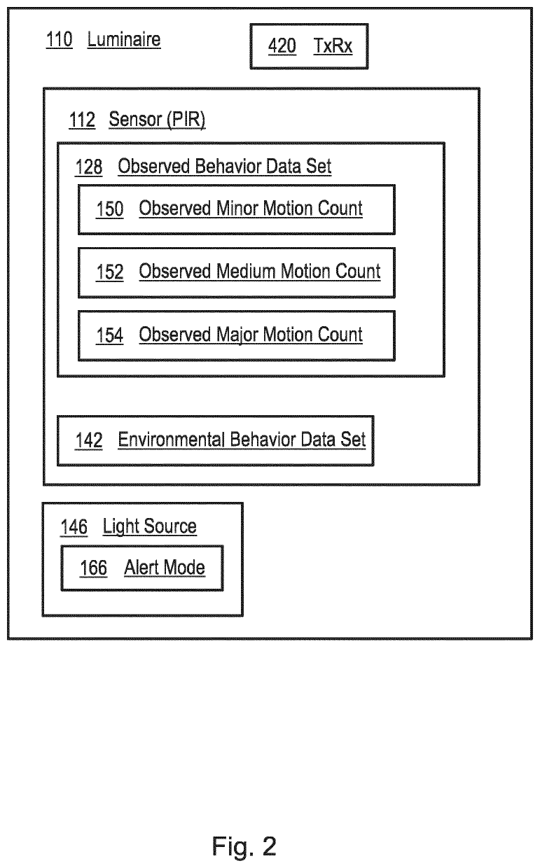

As shown in FIG. 2, the one or more sensors 112 may be arranged in one or more luminaires 110. The one or more luminaires 110 may be positioned above the plurality of workstations 106. The “X′s” of FIG. 4 indicate the placement of the sensors 112 throughout the environment 104. Depending on their placement, some of the sensors 112 may be positioned to monitor multiple workstations 106 within their field of view, while other sensors may be positioned to monitor only one workstation 106, while still others may not have any workstations 106 within their field of view.

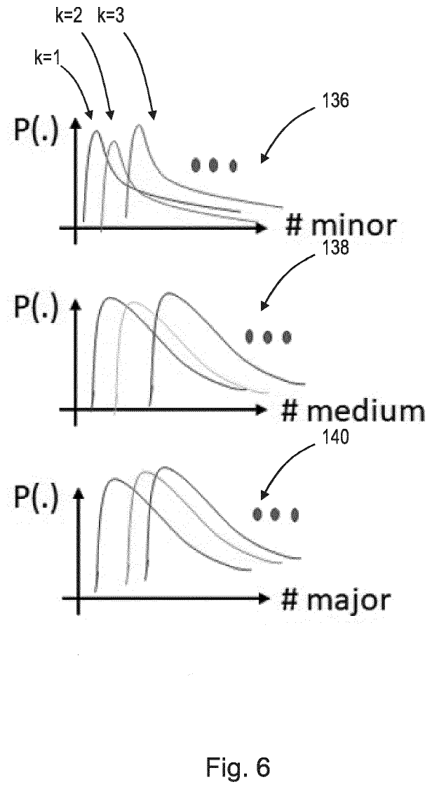

The controller 102 may be configured to receive an expected sensor behavior model 114 for each of the one or more sensors 112. The expected sensor behavior model 114 represents the expected behavior of each sensor 112 when k-number of occupied workstations 106 are within the field of view of the sensor 112. The expected sensor behavior model 114 for each of the one or more sensors 112 may include at least one of a sensor minor motion probability distribution 136, a sensor medium motion probability distribution 138, and a sensor major motion probability distribution 140. Depending on the environment 104 and layout 120, the system may use any appropriate combination of one of, two of, or all three of the sensor minor motion probability distribution 136, the sensor medium motion probability distribution 138, and the sensor major motion probability distribution 140. Example expected probability distributions are illustrated in FIG. 6. As an example, the minor motion probability distribution 136 may be represented by the following equation using beta distribution B (a, b):

$$P ( \# of minor motions = x \vert \# of occupied desks = k ) = k = \frac{{{x}^{a - 1} ( 1 - x )}^{b - 1}}{B ( a , b )}$$

where beta distribution

$$B ( a , b ) = \frac{Γ ( a ) Γ ( b )}{Γ ( a + b )} ,$$

and Γ( ) is a standard Gamma function. Beta distributions are utilized to model the probability distribution of motion counts, as they are able to capture the varying peaks and tails of the distributions in a flexible fashion. The parameters a and b control the shape of the beta distribution; the peak and the tail of the distribution can be adapted by changing a and b. Γ(a) may be defined as follows:

Γ(a)=∫₀^{∞}x^{a-1}e^{-x}dx

Parameters a and b may be selected or learned by the system 100 to conform to observed distribution patterns. For example, the system may know that, when a sensor 112 has 2 individuals within its field of view, the probability of detecting 1 minor motion is 0.10, the probability of detecting 5 minor motions is 0.06, the probability of detecting 10 minor motions is 0.03, and the probability of detecting 15 minor motions is 0.01. The system 100 then may estimate the parameters a and b such that distribution
P(# of minor motions=x|# of occupied desks=k) aligns with this observed probability.

As shown in FIG. 6, the expected counts increase with the number of occupied workstations 106 in the field of view of the sensor 112. The expected sensor behavior model 114 may be generated based on previously collected data from the environment 104 or similar environments.

In a further example, the expected behavior sensor model 114 may further incorporate the expected orientation of the individuals at each workstation 106. The data collected by the sensors 112 may be impacted by the orientation of the monitored individuals due to the front of the human body emitting more heat than the back. The impact of the orientation of the individuals may be incorporated into layout 120, leading to a modification of the sensor minor motion probability distribution 136, sensor medium motion probability distribution 138, and sensor major motion probability distribution 140. For an example, the minor motion probability distribution 136 accounting for orientation may be represented by:

$$P ( \# of minor motions = x \vert \begin{matrix}occupied desks facing forward = {k}_{1} , \\ occupied desks facing backward = {k}_{2}\end{matrix} ) = \frac{{{x}^{a - 1} ( 1 - x )}^{b - 1}}{B ( a , b )}$$

The controller 102 may be further configured to generate an adjusted sensor behavior model 116 for each of the one or more sensors 112. The adjusted behavior sensor model 116 may be generated based on the expected sensor behavior model 114 for each of the one or more sensors 112 and an environment adjustment model 118 for each of the one or more sensors 112. The environment adjustment model 118 represents the impacts of the environment 104, including any barriers 108, on the information captured by the sensors 112. In the example of PIR sensors, the infrared signals captured by the sensors will be partially absorbed by the acrylic glass or PLEXIGLASS of any transparent barriers 108, reducing the strength of the signals captured by the sensors 112. The system 100 uses the environmental adjustment model 118 to correct for this impact by modifying the expected sensor behavior model 114 accordingly. In an alternative example, the environment adjustment behavior model 118 may be used to compensate for infrared absorption by (1) modifying the observed behavior data set 128 captured by the sensors 112 during normal use of the environment or (2) calibrating the settings of the sensors 112 to compensate for the infrared absorption.

According to an example, the controller 102 may be configured to determine the environmental adjustment model 118 by: (1) capturing, via the one or more sensors 112, an environmental behavior data set 142 when the environment 104 is unoccupied; and (2) calculating the environment adjustment model 118 for each of the one or more sensors 112 based on the environmental behavior data set 142 and the expected behavior model 114 for each of the one or more sensors 112. In the example of an open office, the sensors 112 may be configured to capture the environmental behavior data 142 after work hours. The environmental behavior data 142 may include a subset of data with the barriers 108 installed, and a subset of data with the barriers 108 uninstalled. In this way, the system 100 can learn how the barriers 108 impact the infrared radiation detected by the sensors 112, and configure the environment adjustment model 118 to calibrate the expected sensor behavior model 114 for these impacts. In an alternative example, the controller 102 may retrieve the environmental adjustment model 118 from memory 250 or from an external source, such as a central monitoring station.

The controller 102 may be further configured to receive a layout 120 of the environment 104. As discussed above, an example layout is shown in FIG. 4. The layout 120 may include a plurality of workstation locations 122 and one or more sensor locations 124. The layout 120 may also include data regarding the height of the ceiling of the environment 104, or the height of the sensors 112. Each workstation location 122 may have an occupancy state 132 of occupied or unoccupied. The layout 120 of FIG. 4 designates occupied workstations with a circle and sensor locations with an “X”. As shown in FIG. 4, the workstations 106 are arranged in an alternating occupied/unoccupied manner to enable proper social distancing. As can be seen in FIG. 4, some of the sensor locations 124 are proximate to one or more of the occupied workstations, while other sensor locations 122 are not.

In an example, the system 100 may create a subset of “active” sensors 112 corresponding to sensor locations 122 proximate to occupied workstations, as well as a related subset of “inactive” sensors 112 corresponding to sensor locations 122 distal to the occupied workstations. According to an example, all of the sensors 112, whether “active” or “inactive”, capture and transmit data at the same rate. In certain, rare instances, the system 100 may then deactivate the “inactive” sensors 112 during subsequent data capturing to conserve system 100 data and power resources.

The controller 102 may be further configured to generate an expected layout behavior model 126. The expected layout behavior model 126 may be generated based on the layout 120 and the adjusted sensor behavior model 116. Accordingly, the expected layout behavior model 126 represents the motion counts expected to be generated by the sensors 112, adjusted for the barriers 108, for the sensor locations 124, workstation locations 122, and workstation occupancy states 132 as depicted in the layout 120.

For example, according to the layout 120, a sensor 112 at a sensor location 124 may have three workstation locations 122 within its field of view. However, further according to the layout 120, only one of those workstation locations 122 may be occupied when practicing proper social-distancing. Accordingly, the expected layout behavior model 126 will expected minor, medium, and major motion counts corresponding to one workstation location 122 being occupied. If all three workstation locations 122 are occupied, the motion counts captured by the sensor will differ significantly from the expected layout behavior model 126, and causing the system to determine that the social-distancing policy of the environment 104 has been violated.

The expected layout behavior model 126 may include a layout minor motion probability distribution 144, a layout medium motion probability distribution 146, and a layout major motion probability distribution 148. The probability distributions utilized by expected layout behavior model 126 may correspond to the relevant distributions of the expected sensor behavior model 114. For example, if the system 100 utilizes only the sensor major motion probability distribution 140, the expected layout behavior model 126 may only include the corresponding layout major motion probability distribution 148.

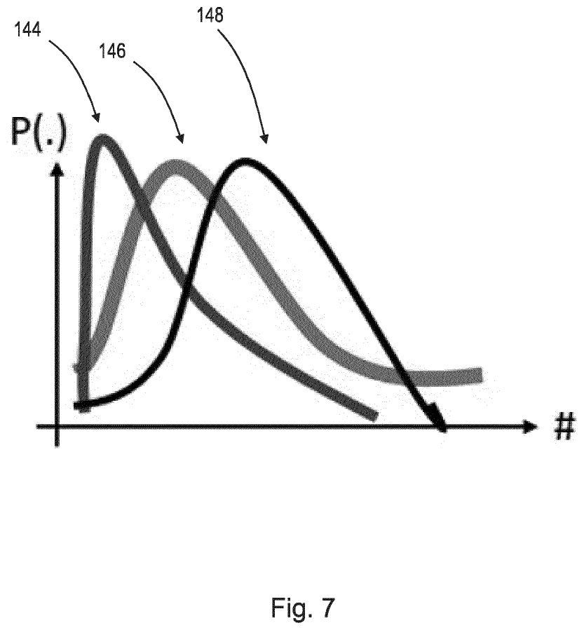

Example probability distributions for an expected layout behavior model 126 are shown in FIG. 7. The probability distributions of FIG. 7 represent the probabilities of total minor, medium, and major motion counts among all activated sensors 112 in the social-distanced environment 104 described by layout 120, and are derived from the probability distributions of the expected sensor behavior model 114 (the sensor minor motion probability distribution 136, the sensor medium motion probability distribution 138, and the sensor major motion probability distribution 140), the characteristics of the environment 104, and the layout 120 of the workstation locations 122 and sensor locations 124. As described below, deviations from these probability distributions may be indicative of individuals within the environment failing to properly social-distance, despite the provided layout 120. Further, an extreme deviations may be indicative of an environment 104 which fails to conform to the provided layout 120. For example, a failure to conform may be allowing an individual to occupy a workstation location 122 designated as unoccupied.

In a further example, the expected layout behavior model 126 may be a vector model of expected motion counts of each individual sensor 112. In this example, the expected layout behavior model 126 may include expected minor, medium, and major motion counts for each sensor 112. While this vector model would be a more precise representation of the expected behavior of the sensors, generating this model and then utilizing it to determine a social-distancing state would require significantly greater computational resources than a model which simply totals the motion count probabilities of each sensor 112, as previously described.

In an example, the expected layout behavior model 126 may be based on several different layouts 120 corresponding to different workstation 106 occupancy state 132 configurations. Incorporating multiple, properly social-distanced layouts 120 into the expected layout behavior model 126 allows for the system 100 to simultaneously evaluate the environment 104 for social distancing with several different combinations of workstation 106 occupancy states 132.

The controller 102 may be further configured to capture, via the one or more sensors 112, an observed behavior data set 128 during a measurement period 130. The observed behavior data set 128 should be captured during normal usage of the environment 104, such as during regular business hours of an open office. The observed behavior data set 128 may include an observed minor motion count 150, an observed medium motion count 152, and an observed major motion count 154. Each motion count 150, 152, 154 may be the sum of the motion counts of all of the activated sensors 112.

According to an example, the measurement period 130 may be five minutes. In an alternative example, the measurement period 130 may be two hours. In most examples, a longer measurement period 130 will correspond with a higher degree of accuracy. The measurement period 130 should of sufficient length to capture an observed behavior data set 128 during a representative period of occupancy of the environment 104. The motion counts are relatively coarse signals which are not ideal for real-time monitoring. A measurement period 130 of just several seconds will be unlikely to capture motion necessary to compare to the probability distributions of the expected layout behavior model 126. In an alternative example, the analog response of the PIR sensors 112 may be used to allow the system 100 to evaluate social distancing in real-time.

Once the sensors 112 have captured the observed behavior data set 128, the controller 102 may be further configured to determine a social distancing state 134 of individuals in the environment 104 as distanced or not-distanced. Determining the social distancing state 134 may be based on the observed behavior data set 128 and the expected layout behavior model 126. Accordingly, significant deviations of the observed behavior data set 128 from the expected layout behavior model 126 may result in the determination of the social distancing state 134 to be not-distanced.

According to an example, the social distancing state 134 may be determined by (1) calculating, via a hypothesis test 156, a social distancing p-value 158 based on the observed behavior data set 128 and the expected layout behavior model 126; (2) assigning, if the social distancing p-value 158 is less than or equal to a social distancing threshold 160, the social distancing state 134 to distanced; and (3) assigning, if the social distancing p-value 158 is greater than the social distancing threshold 160, the social distancing state 134 to not-distanced.

According to an example, the controller 102 may be further configured to transmit a warning signal 162 if the social distancing state 134 of the environment 104 is not-distanced. For example, the warning signal 162 may be received by a central monitoring station, causing a supervisor to investigate the environment 104 to enforce social distancing. Similarly, the warning signal 162 may be received by the workstation 106 to inform the individuals in the environment 104 that proper social distancing is not being exercised. In a further example, one or more of the luminaires 110 may receive the warning signal 162 and enter an alert mode 166, during which changing colors or blinking lights may alert the individuals of the environment 104 that social distancing protocols are not being followed.

In a further example, the system 100 may be used to monitor social distancing of people and/or animals in an environment 104 such as a barn or market. Due to speculation regarding the spread of infectious disease from animal-to-animal or animal-to-human, similar social distancing practices involving approved layouts 120 may be implemented in barns or markets.

In another aspect, a method 500 for monitoring social distancing in of individuals an environment with a plurality of workstations separated by one or more barriers is provided. The method 500 may include receiving 502, via a controller communicatively coupled to one or more sensors within the environment, an expected behavior model for each of the one or more sensors.

In a further example, the environment 104 may only feature barriers 108 at times of high pandemic risks. When the virus risks are considered low, the barriers 108 may be removed. The system 100 may be used to detect the removal of the barriers 108 and modify (such as by reducing or removing) the environmental adjustment model 118.

The method 500 may further include generating 504 an adjusted behavior model for each of the one or more sensors based on the expected behavior model for each of the one or more sensors and an environment adjustment model for each of the one or more sensors. The method 500 may further include receiving 506 a layout of the environment, the layout comprising the plurality of workstations and the one or more sensors, wherein each workstation has an occupancy state of occupied or unoccupied. The method 500 may further include generating 508 an expected layout behavior model based on the layout and the adjusted behavior model. The method may further include capturing 510, via the one or more sensors, an observed behavior data set during a measurement period. The method may further include determining 512 a social distancing state of the individuals in the environment as distanced or not-distanced based on the observed behavior data set and the expected layout behavior model.

According to an example, the method 500 may further include capturing 514, via the one or more sensors, an environmental behavior data set when the environment is unoccupied. The method 500 may further include calculating 516 the environment adjustment model for each of the one or more sensors based on the environmental behavior data set and the expected behavior model for each of the one or more sensors.

According to an example, determining 512 the social distancing state may include calculating 518, via a hypothesis test, a social distancing p-value based on the observed behavior data set and the expected layout behavior model. Determining 512 the social distancing state may further include assigning 520, if the social distancing p-value is less than or equal to a social distancing threshold, the social distancing state to distanced. Determining 512 the social distancing state may include assigning 522, if the social distancing p-value is greater than the social distancing threshold, the social distancing state to not-distanced.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects may be implemented using hardware, software or a combination thereof. When any aspect is implemented at least in part in software, the software code can be executed on any suitable processor or collection of processors, whether provided in a single device or computer or distributed among multiple devices/computers.

The present disclosure may be implemented as a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions may be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant may be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples may be practiced otherwise than as specifically described and claimed. Examples of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A system for monitoring social distancing of individuals in an environment with a plurality of workstations separated by one or more barriers, comprising a controller communicatively coupled to one or more sensors within the environment, wherein the controller is configured to:
receive an expected sensor behavior model for each of the one or more sensors, the expected sensor behavior model representing an expected behavior each of the one or more sensors when one or more of the plurality of workstations are within a field of view of the one or more sensors;
generate an adjusted sensor behavior model for each of the one or more sensors based on the expected sensor behavior model for each of the one or more sensors and an environment adjustment model for each of the one or more sensors, the environment adjustment model representing an impact of the environment on information captured by each of the one or more sensors;
receive a layout of the environment, the layout comprising a plurality of workstation locations and one or more sensor locations, wherein each workstation location has an occupancy state of occupied or unoccupied;
generate an expected layout behavior model based on the layout and the adjusted sensor behavior model;
capture, via the one or more sensors, an observed behavior data set during a measurement period; and
determine a social distancing state of individuals in the environment as distanced or not-distanced based on the observed behavior data set and the expected layout behavior model.

2. The system of claim 1, wherein the expected sensor behavior model for each of the one or more sensors comprises a sensor minor motion probability distribution, a sensor medium motion probability distribution, and a sensor major motion probability distribution.

3. The system of claim 1, wherein the controller is further configured to:
capture, via the one or more sensors, an environmental behavior data set when the environment is unoccupied; and
calculate the environment adjustment model for each of the one or more sensors based on the environmental behavior data set and the expected behavior model for each of the one or more sensors.

4. The system of claim 1, wherein the expected layout behavior model comprises a layout minor motion probability distribution, a layout medium motion probability distribution, and a layout major motion probability distribution.

5. The system of claim 1, wherein the observed behavior data set comprises an observed minor motion count, an observed medium motion count, and an observed major motion count.

6. The system of claim 1, wherein determining the social distancing state comprises:
calculating, via a hypothesis test, a social distancing p-value based on the observed behavior data set and the expected layout behavior model;
assigning, if the social distancing p-value is less than or equal to a social distancing threshold, the social distancing state to distanced; and
assigning, if the social distancing p-value is greater than the social distancing threshold, the social distancing state to not-distanced.

7. The system of claim 1, wherein the barriers are acrylic glass.

8. The system of claim 1, wherein the one or more sensors are arranged in one or more luminaires.

9. The system of claim 5, wherein the one or more luminaires are positioned above the plurality of workstations.

10. The system of claim 1, wherein the measurement period is about five minutes.

11. The system of claim 1, wherein the one or more sensors include one or more passive infrared sensors, one or more single pixel thermopile sensors, one or more multipixel thermopile sensors, and/or one or more microwave radar sensors.

12. The system of claim 1, wherein the controller is further configured to transmit a warning signal if the social distancing state of the environment is not-distanced.

13. A method for monitoring social distancing in of individuals an environment with a plurality of workstations separated by one or more barriers, comprising:
receiving, via a controller communicatively coupled to one or more sensors within the environment, an expected behavior model for each of the one or more sensors, the expected sensor behavior model representing an expected behavior of each of the one or more sensors when one or more of the plurality of workstations are within a field of view of the one or more sensors;
generating, via the controller, an adjusted behavior model for each of the one or more sensors based on the expected behavior model for each of the one or more sensors and an environment adjustment model for each of the one or more sensors, the environment adjustment model representing an impact of the environment on information captured by each of the one or more sensors;
receiving, via the controller, a layout of the environment, the layout comprising the plurality of workstation locations and the one or more sensor locations, wherein each workstation location has an occupancy state of occupied or unoccupied;
generating, via the controller an expected layout behavior model based on the layout and the adjusted behavior model;
capturing, via the one or more sensors, an observed behavior data set during a measurement period; and
determining, via the controller, a social distancing state of the individuals in the environment as distanced or not-distanced based on the observed behavior data set and the expected layout behavior model.

14. The method of claim 13, further comprising:
capturing, via the one or more sensors, an environmental behavior data set when the environment is unoccupied; and
calculating the environment adjustment model for each of the one or more sensors based on the environmental behavior data set and the expected behavior model for each of the one or more sensors.

15. The method of claim 13, wherein determining the social distancing state comprises:
calculating, via a hypothesis test, a social distancing p-value based on the observed behavior data set and the expected layout behavior model;
assigning, if the social distancing p-value is less than or equal to a social distancing threshold, the social distancing state to distanced; and
assigning, if the social distancing p-value is greater than the social distancing threshold, the social distancing state to not-distanced.
